(19) United States
(12) Patent Application Publication
(10) Pub. No.: US 2022/0177166 A1
(43) Pub. Date: Jun. 9, 2022

(54) SPACECRAFT THERMAL AND FLUID MANAGEMENT SYSTEMS

(71) Applicant: MOMENTUS INC., Santa Clara, CA (US)

(72) Inventors: Mikhail Kokorich, Santa Clara, CA (US); Joel Sercel, Lake View Terrace, CA (US); Aaron Mitchell, Santa Clara, CA (US); Gedi Minster, Santa Clara, CA (US); Yuqi Wang, San Jose, CA (US); Lee Wilson, Santa Clara, CA (US); James Small, Sonoita, AZ (US)

(21) Appl. No.: 17/437,044

(22) PCT Filed: Mar. 5, 2020
(86) PCT No.: PCT/US20/21237

§ 371 Date: Sep. 7, 2021

Related U.S. Application Data
(63) Continuation of application No. 16/773,901, filed on Jan. 27, 2020.
(60) Provisional application No. 62/819,355, filed on Mar. 15, 2019.
(60) Provisional application No. 62/817,206, filed on Mar. 12, 2019.
(60) Provisional application No. 62/814,484, filed on Mar. 6, 2019.
(60) Provisional application No. 62/813,481, filed on Mar. 4, 2019.

(51) Int. Cl. B64G 1/40; F02K 9/56; F17C 7/04

(52) U.S. Cl. CPC B64G 1/402; F02K 9/563; F17C 7/04; F17C 2270/0197; F17C 2225/0123; F17C 2225/013; F17C 2223/0153

(57) ABSTRACT

To manage propellant in a spacecraft, the method of this disclosure includes storing propellant in a tank as a mixture of liquid and gas; transferring the propellant out of the tank; converting the mixture of liquid and gas propellant into a single phase, where the single phase is either liquid or gaseous; and supplying the single phase of the propellant to a thruster.

### FIELD OF THE DISCLOSURE

The disclosure generally relates to operating a spacecraft and more specifically to managing the fluid propellant and heat in the spacecraft systems.

### BACKGROUND

With increased commercial and government activity in the near space, a variety of spacecraft and missions are under development. For example, some spacecraft may be dedicated to delivering payloads (e.g., satellites) from one orbit to another. In the course of missions, managing the propellant, other fluids, and heat efficiently remains a challenge.

### SUMMARY

Generally speaking, the techniques of this disclosure improve management of thermal energy in a spacecraft as well as transfer of energy between subsystems of the spacecraft. As discussed in more detail below, these techniques allow the spacecraft to more efficiently utilize a fluid propellant stored in multiple phases (e.g., liquid and gaseous), remove excess heat from subsystems, store excess heat in a propellant tank, direct stored heat from a propellant tank to another component, etc.

One example embodiment of the techniques of this disclosure is a method for managing propellant in a spacecraft. The method includes storing propellant in a tank as a mixture of liquid and gas, transferring the propellant out of the tank, converting the mixture of liquid and gas propellant into a single phase, where the single phase is either liquid or gaseous, and supplying the single phase of the propellant to a thruster.

Another example embodiment of these techniques is a system for managing propellant in a spacecraft. The system includes a tank for storing propellant as a mixture of liquid and gas; a two-phase intake device configured to operate at a variable volume flow rate; a sensor configured to generate a signal indicative of an amount of liquid in the mixture of liquid and gas; and a controller configured to vary the variable flow rate of the two-phase intake device based at least in part on the signal generated by the sensor.

Still another example embodiment of these techniques is a method for transferring propellant out of a tank that stores the propellant in microgravity as a mixture of gas and liquid. The includes pumping with a two-phase pump a certain volume of propellant via an outlet line; determining, using a sensor, a ratio of liquid and gas in the certain volume; and setting a speed of pumping with the two-phase pump based at least in part on the determined ratio.

Another example embodiment of these techniques is a system for managing heat in a spacecraft. The system includes a tank configured to store a propellant; a microwave electro-thermal (MET) thruster configured to consume the propellant to generate thrust, the thruster including a microwave source that, in operation, generates excess heat; and a heat exchanger configured to transfer the excess heat to the propellant stored in thank.

Yet another embodiment of these techniques is a method for managing heat in a spacecraft. The method includes operating a microwave electro-thermal (MET) thruster including a microwave source. Operating the MET thruster includes: consuming propellant, and generating excess heat. The method further includes heating an amount of the propellant using the excess heat; storing the excess heat by storing the heated amount of the propellant in a tank; and directing the excess heat to a subsystem of the spacecraft.

Another embodiment of these techniques is a system for managing heat in a spacecraft. The system includes a tank configured to store a propellant; a microwave electro-thermal (MET) thruster configured to consume the propellant to generate thrust, the thruster including a microwave source that, in operation, generates excess heat; a heat exchanger configured to transfer the excess heat to a portion of the propellant in a conduit, thereby heating the portion of the propellant; and a pump configured to direct the heated portion of the propellant to a heat sink.

Another embodiment of these techniques is a system for managing heat in a spacecraft. The system includes a deployable radiator; and a conduit having a flexible section and configured for carrying a propellant, the conduit in a thermally conductive connection with the deployable radiator.

Another embodiment of these techniques is a system for managing heat in a spacecraft. The system includes a radiator, disposed at a back side of a solar panel; a conduit having a flexible section and configured for carrying a propellant, the conduit in a thermally conductive connection with the radiator; and a pump configured to pump propellant through the conduit.

Another embodiment of these techniques is a system for storing propellant in microgravity. The system includes a tank for storing propellant as a mixture of liquid and gas; and an agitator, configured to increase circulation of the mixture of liquid and gas in microgravity; and a controller configured to activate the agitator

### BRIEF DESCRIPTION OF THE DRAWINGS

FIG. 1 is a block diagram of an example spacecraft in which the techniques of this disclosure can be implemented;

FIGS. 2A-C illustrate three configurations of a propellant management system for converting a two-phase mixture of propellant stored in a tank into a single phase for supplying the propellant to a thruster;

FIG. 3 illustrates an of a propellant management system for converting a two-phase mixture of propellant into a single phase using a piston pump;

FIG. 4A illustrates a system for controlling a volume flow rate of a two-phase mixture from a tank based on a sensor for detecting a composition of the two-phase mixture;

FIG. 4B illustrates a system for controlling a volume flow rate of a two-phase mixture from a tank based on a sensor for detecting a composition of a sample of the two-phase mixture removed from the tank by a sampling pump;

FIG. 5 illustrates a general architecture of using a propellant system for managing heat in a spacecraft;

FIG. 6 illustrates an example implementation of using a propellant system for managing heat in a spacecraft by pumping propellant through one or more heat exchangers.

FIG. 7A illustrates a deployable radiator thermally connected to a propellant conduit with a flexible section.

FIG. 7B illustrates a radiator attached to a back side of a solar array and thermally connected to a propellant conduit.

FIG. 8A illustrates a tank for storing propellant, the tank including an ultrasonic transducer acting as an agitator for increasing circulation of a mixture of liquid and gas in microgravity.

FIG. 8B illustrates a tank for storing propellant, the tank including a fan acting as an agitator for increasing circulation of a mixture of liquid and gas in microgravity.

FIG. 9 is a cutaway view illustrating components of a system for converting a mixed-phase propellant flow to an all-liquid propellant.

FIG. 10 is a schematic view of the system architecture for the system illustrated in FIG. 9.

FIG. 11 is a cutaway view illustrating components of a system for converting a mixed-phase propellant flow to an all-liquid propellant using a fast-acting valve.

FIG. 12 illustrates an example peristaltic roller pump.

FIG. 13 illustrates an example peristaltic roller pump that uses compressible wicking material.

FIG. 14 is a perspective illustration of certain components of a roller pump which is designed for wide area wicks.

FIG. 15 further illustrates additional components of a wide roller pump of FIG. 14.

FIG. 16 illustrates a peristaltic piston pump.

FIG. 17 illustrates a hinged plate peristaltic pump.

FIG. 18 illustrates a hinged plate peristaltic pump, as illustrated in FIG. 17, which has been installed inside a closed pressure vessel (or a tank).

FIG. 19 is a schematic diagram of an embodiment for propellant management in a spacecraft system.

FIG. 20 schematically illustrates a typical magnetron.

FIG. 21 illustrates a magnetron cooled using a heat pipe system.

FIG. 22 illustrates a magnetron cooled using a heat pipe system, with the heat delivered to an interior component of a spacecraft.

### DETAILED DESCRIPTION

A spacecraft of this disclosure may be configured for transferring a payload from a lower energy orbit to a higher energy orbit according to a set of mission parameters. The mission parameters may include, for example, a time to complete the transfer and an amount of propellant and/or fuel available for the mission. Generally, the spacecraft may collect solar energy and use the energy to power one or more thrusters. Different thruster types and/or operating modes may trade off the total amount of thrust with the efficiency of thrust with respect to fuel or propellant consumption, defined as a specific impulse.

The spacecraft in some implementations includes thrusters of different types to improve the efficiency of using solar energy when increasing orbital energy. In some implementations, the spacecraft uses the same subsystems for operating the different-type thrusters, thereby reducing the mass and/or complexity of the spacecraft, and thus decreasing mission time while maintaining and/or improving reliability. Additionally or alternatively, the spacecraft can choose or alternate between thrusters of different types as primary thrusters. The spacecraft can optimize these choices for various mission goals (e.g., different payloads, different destination orbits) and/or mission constraints (e.g., propellant availability). Example optimization of these choices can include variations in collecting and storing solar energy as well as in controlling when the different thrusters use the energy and/or propellant, as discussed below.

Typical fluids managed in a spacecraft include: water, ammonia, hydrocarbon liquids, and cryogenic liquids such as liquid oxygen. At the start of a mission, a container is typically completely filled with a useful fluid. As the mission progresses, continuing extraction of the fluid may leave the container partially filled with liquid and partially with a gaseous vapor-phase of the fluid. Surface tension causes the liquid phase to agglomerate into drops of various sizes and shapes. The drops float around within the container. Liquid drops are separated from each other and often from the container walls by spaces filled with the vapor phase. When withdrawing further fluid from the container, the discharge stream may contain a random mixture of liquid drops interspersed with vapor bubbles. The mixture of liquid-phase and vapor-phases complicates pumping and precise metering of fluid flow.

For spacecraft operations in microgravity conditions, phase separation in fluids (e.g., propellant) may be controlled through the use of pressurized collapsing containers, sometimes called accumulators. Pressurized accumulators which use flexible rubber diaphragms or metallic bellows may not be compatible with chemically reactive fluids or with fluids which must be kept at either elevated or cryogenic temperatures. The accumulators also typically have dead spaces and may not be able to completely extract all fluid, leading to unused excess weight. Furthermore, the collapsing mechanisms themselves may add significant weight and complexity to spacecraft systems. Other systems use centrifugal forces from various rotational motion effects, including rotating containers or swirling vertical gas flow, to separate liquid from gas phases; but such systems add to spacecraft angular momentum which can compromise spacecraft pointing and maneuvering capabilities. During some spacecraft maneuvers, a liquid phase may be collected and extracted during non-microgravity events such as spacecraft rotation or thrusting operations, if the mission permits.

It may be preferred to process fluids in their liquid state. Gas-phase vapors typically have a mass density thousands to tens-of-thousands of times lower than the liquid phase. The gas phase mass density depends strongly on the working pressure levels within the system, whereas the mass density of a nearly incompressible liquid changes only very slightly with hydrostatic pressure. Moving and metering of low density gasses requires pumps which can move large volumes through large flow tubes into large pressure vessels in order to move useful amounts of mass. The same mass in liquid phase can be moved with smaller pumps and smaller tubing in inverse proportion to the relative mass density of the liquid. The presented systems for fluid management address the challenges above.

Managing heat in a spacecraft also presents challenges. One of the sources of heat may be a propulsion system. The presented systems for managing heat may improve upon prior art in microwave frequency power generation in space systems. High-efficiency sources of microwave power include magnetrons, gallium-arsenide semiconductor amplifiers, and other solid state devices. Some report electric-to-microwave power conversion efficiencies as high as 90%. Proposed commercial space applications can require nearly continuous microwave power levels above 100 kilowatts or higher. Therefore, approximately tens of kilowatts or more of thermal energy must be removed. Such heat removal, then, can be referred to as “cooling” the generator.

In some space systems, a magnetron may be preferred over other microwave generators because its waste heat is delivered at higher temperatures. Higher temperature waste heat is more readily radiated to space than lower temperature waste heat, therefore allowing for the use of smaller radiators and potentially reducing the weight of the spacecraft into which the magnetron is integrated. The present disclosure describes practical means to remove waste heat directly from the heat generating devices.

Waste heat is efficiently transported to radiators where it is radiated to the cold background of deep space. Alternately, waste heat may be used in the interior of spacecraft or other structures to control temperatures in sensitive systems.

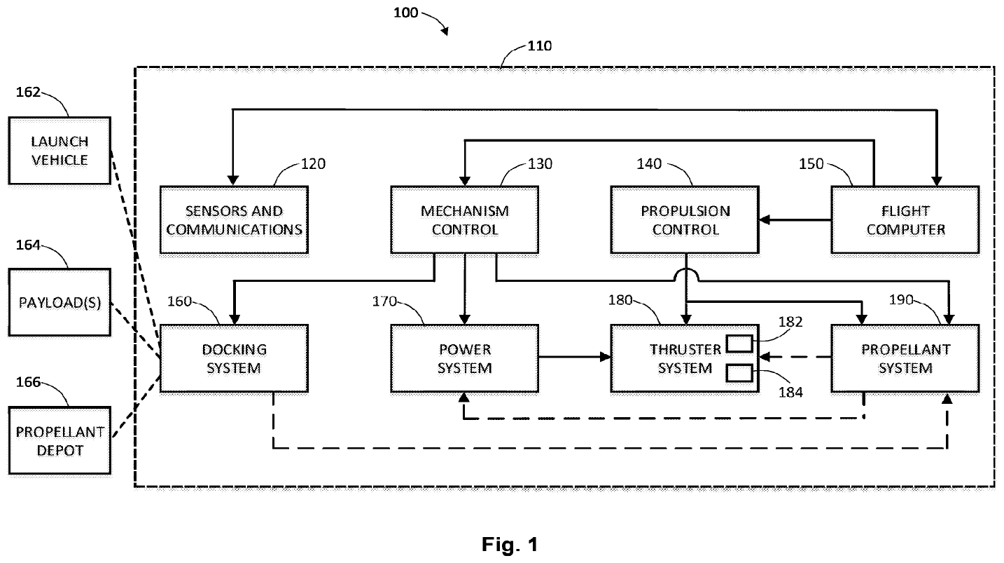

FIG. 1 is a block diagram of a spacecraft 100 configured for transferring a payload between orbits. The spacecraft 100 includes several subsystems, units, or components disposed in or at a housing 110. The subsystems of the spacecraft 100 may include sensors and communications components 120, mechanism control 130, propulsion control 140, a flight computer 150, a docking system 160 (for attaching to a launch vehicle 162, one or more payloads 164, a propellant depot 166, etc.), a power system 170, a thruster system 180 that includes a first thruster 182 and a second thruster 184, and a propellant system 190. Furthermore, any combination of subsystems, units, or components of the spacecraft 100 involved in determining, generating, and/or supporting spacecraft propulsion (e.g., the mechanism control 130, the propulsion control 140, the flight computer 150, the power system 170, the thruster system 180, and the propellant system 190) may be collectively referred to as a propulsion system of the spacecraft 100.

The sensors and communications components 120 may several sensors and/or sensor systems for navigation (e.g., imaging sensors, magnetometers, inertial motion units (IMUs), Global Positioning System (GPS) receivers, etc.), temperature, pressure, strain, radiation, and other environmental sensors, as well as radio and/or optical communication devices to communicate, for example, with a ground station, and/or other spacecraft. The sensors and communications components 120 may be communicatively connected with the flight computer 150, for example, to provide the flight computer 150 with signals indicative of information about spacecraft position and/or commands received from a ground station.

The flight computer 150 may include one or more processors, a memory unit, computer readable media, to process signals received from the sensors and communications components 120 and determine appropriate actions according to instructions loaded into the memory unit (e.g., from the computer readable media). Generally, the flight computer 150 may be implemented any suitable combination of processing hardware, that may include, for example, applications specific integrated circuits (ASICs) or field programmable gate arrays (FPGAs), and/or software components. The flight computer 150 may generate control messages based on the determined actions and communicate the control messages to the mechanism control 130 and/or the propulsion control 140. For example, upon receiving signals indicative of a position of the spacecraft 100, the flight computer 150 may generate a control message to activate one of the thrusters 182, 184 in the thruster system 180 and send the message to the propulsion control 140. The flight computer 150 may also generate messages to activate and direct sensors and communications components 120.

The docking system 160 may include a number of structures and mechanisms to attach the spacecraft 100 to a launch vehicle 162, one or more payloads 164, and/or a propellant refueling depot 166. The docking system 160 may be fluidicly connected to the propellant system 190 to enable refilling the propellant from the propellant depot 166. Additionally or alternatively, in some implementations at least a portion of the propellant may be disposed on the launch vehicle 162 and outside of the spacecraft 100 during launch. The fluidic connection between the docking system 160 and the propellant system 190 may enable transferring the propellant from the launch vehicle 162 to the spacecraft 100 upon delivering and prior to deploying the spacecraft 100 in orbit.

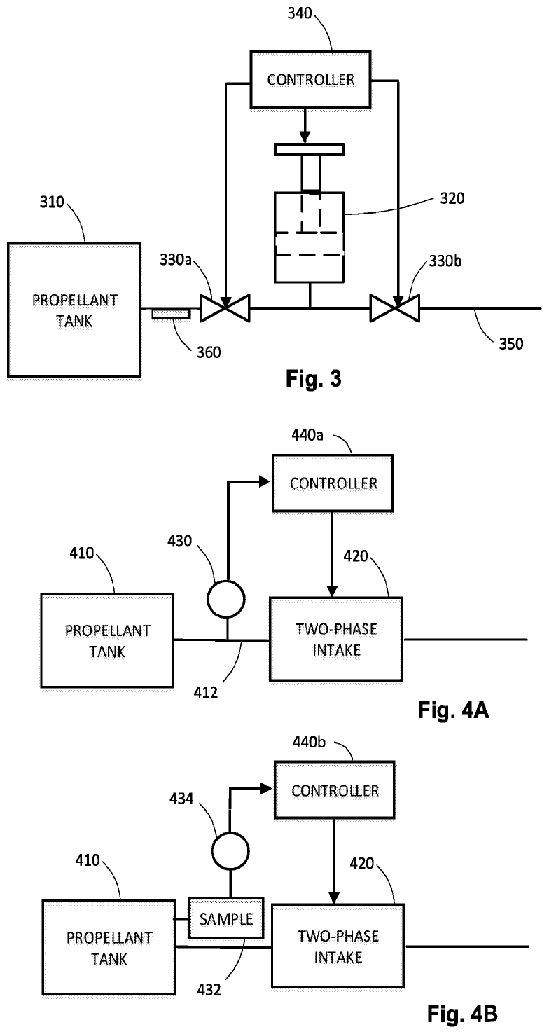

The power system 170 may include components (discussed in the context of FIGS. 4-7) for collecting solar energy, generating electricity and/or heat, storing electricity and/or heat, and delivering electricity and/or heat to the thruster system 180. To collect solar energy into the power system 170, solar panels with photovoltaic cells, solar collectors or concentrators with mirrors and/or lenses, or a suitable combination of devices may collect solar energy. In the case of using photovoltaic devices, the power system 170 may convert the solar energy into electricity and store it in energy storage devices (e.g, lithium ion batteries, fuel cells, etc.) for later delivery to the thruster system 180 and other spacecraft components. In some implementations, the power system 180 may deliver at least a portion of the generated electricity directly to the thruster system 180 and/or to other spacecraft components. When using a solar concentrator, the power system 170 may direct the concentrated (having increased irradiance) solar radiation to photovoltaic solar cells to convert to electricity. In other implementations, the power system 170 may direct the concentrated solar energy to a solar thermal receiver or simply, a thermal receiver, that may absorb the solar radiation to generate heat. The power system 170 may use the generated heat to power a thruster directly, as discussed in more detail below, to generate electricity using, for example, a turbine or another suitable technique (e.g., a Stirling engine). The power system 170 then may use the electricity directly for generating thrust or store electric energy as briefly described above, or in more detail below.

The thruster system 180 may include a number of thrusters and other components configured to generate propulsion or thrust for the spacecraft 100. Thrusters may generally include main thrusters that are configured to substantially change speed of the spacecraft 100, or as attitude control thrusters that are configured to change direction or orientation of the spacecraft 100 without substantial changes in speed. In some implementations, the first thruster 182 and the second thruster 184 may both be configured as main thrusters, with additional thrusters configured for attitude control. The first thruster 182 may operate according to a first propulsion technique, while the second thruster 184 may operate according to a second propulsion technique.

For example, the first thruster 182 may be a microwave-electro-thermal (MET) thruster. In a MET thruster cavity, an injected amount of propellant may absorb energy from a microwave source (that may include one or more oscillators) included in the thruster system 180 and, upon partial ionization, further heat up, expand, and exit the MET thruster cavity through a nozzle, generating thrust.

The second thruster 184 may be a solar thermal thruster. In one implementation, propellant in a thruster cavity acts as the solar thermal receiver and, upon absorbing concentrated solar energy, heats up, expands, and exits the nozzle generating thrust. In other implementations, the propellant may absorb heat before entering the cavity either as a part of the thermal target or in a heat exchange with the thermal target or another suitable thermal mass thermally connected to the thermal target. In some implementations, while the propellant may absorb heat before entering the thruster cavity, the thruster system 180 may add more heat to the propellant within the cavity using an electrical heater or directing a portion of solar radiation energy to the cavity.

The propellant system 190 may store the propellant for use in the thruster system 180. The propellant may include water, hydrogen peroxide, hydrazine, ammonia or another suitable substance. The propellant may be stored on the spacecraft in solid, liquid, and/or gas phase. To that end, the propellant system 190 may include one or more tanks. To move the propellant within the spacecraft 100, and to deliver the propellant to one of the thrusters, the propellant system may include one or more pumps, valves, and pipes. As described below, the propellant may also store heat and/or facilitate generating electricity from heat, and the propellant system 190 may be configured, accordingly, to supply propellant to the power system 170.

The mechanism control 130 may activate and control mechanisms in the docking system 160 (e.g., for attaching and detaching payload or connecting with an external propellant source), the power system 170 (e.g., for deploying and aligning solar panels or solar concentrators), and/or the propellant system (e.g., for changing configuration of one or more deployable propellant tanks). Furthermore, the mechanism control 130 may coordinate interaction between subsystems, for example, by deploying a tank in the propellant system 190 to receive propellant from an external source connected to the docking system 160.

The propulsion control 140 may coordinate the interaction between the thruster system 140 and the propellant system 190, for example, by activating and controlling electrical components (e.g., a microwave source) of the thruster system 140 and the flow of propellant supplied to thrusters by the propellant system 190. Additionally or alternatively, the propulsion control 140 may direct the propellant through elements of the power system 170. For example, the propellant system 190 may direct the propellant to absorb the heat (e.g., at a heat exchanger) accumulated within the power system 170. Vaporized propellant may then drive a power plant (e.g., a turbine, a Stirling engine, etc.) of the power system 170 to generate electricity. Additionally or alternatively, the propellant system 190 may direct some of the propellant to charge a fuel cell within the power system 190.

The subsystems of the spacecraft may be merged or subdivided in different implementations. For example, a single control unit may control mechanisms and propulsion. Alternatively, dedicated controllers may be used for different mechanisms (e.g., a pivot system for a solar concentrator), thrusters (e.g., a MET thruster), valves, etc. In the following discussion, a controller may refer to any portion or combination of the mechanism control 130 and/or propulsion control 140.

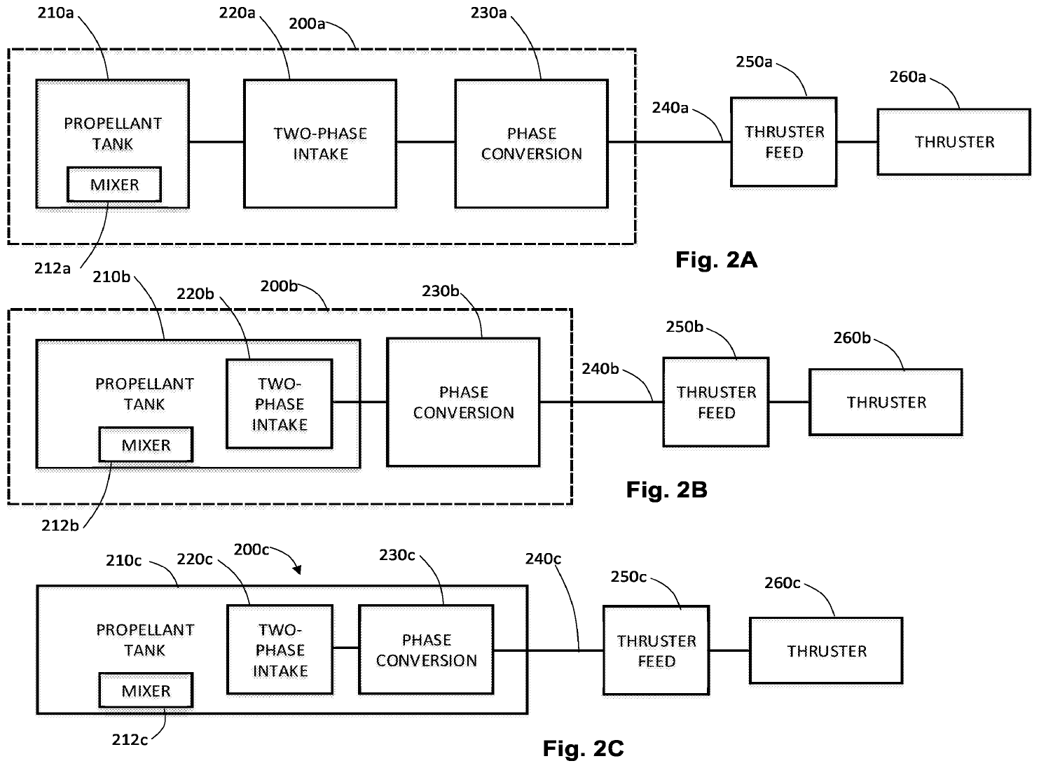

FIGS. 2A-C illustrate three configurations of propellant management systems 200a-c for converting a two-phase mixture of propellant stored in a tank into a single phase for supplying the propellant to a thruster. The propellant management systems 200a-c include propellant tanks 210a-c, with optional mixers 212a-c (also referred to as agitators), sequentially fluidicly coupled to corresponding two-phase intake components 220a-c and phase-conversion components 230a-c. Outlet lines 240a-c of the propellant management systems 200a-c supply propellant to corresponding thruster feeds 250a-c and thrusters 260a-c.

In FIG. 2A, the configuration 200a includes the propellant tank 210a, optionally, with the mixer 212a disposed within the tank 210a. The two-phase intake component 220a receives a mixture of liquid and gas propellant and transfers the mixture out the tank 210a. The two-phase intake component 220a transfers the two-phase mixture to the phase conversion component 230a. In some implementations, the two-phase intake component 220a may include a two-phase pump. In other implementations, a single-phase pump may be connected downstream of the phase conversion component 230a to establish a pressure gradient across the two-phase intake component 220a to draw the propellant out of the tank 210a.

The phase conversion component 230a is configured to convert the two-phase mixture of the propellant into a single phase. The single-phase propellant exiting the phase-conversion component 230a through the outlet line 240a may be either all liquid or all gas. The outlet line 240a may supply the single phase of the propellant to the thruster feed component 250a. The thruster feed component 250a may, for example, accumulate liquid propellant and supply the propellant to a thruster 260a when the thruster is in operation. The thruster feed component 250a may vaporize the liquid propellant prior to supplying in to the thruster 260a. In some implementations, the propellant management system 200a may supply the propellant directly to the thruster 260a in gas phase.

The phase conversion component 230a may convert the mixture of liquid and gas propellant directly into liquid by increasing pressure and/or decreasing temperature to condense the gas portion of the propellant. In some implementations, the two phase intake component 220a may include a section of porous wicking material (e.g., a sponge) that adsorbs and wicks the liquid and gas propellant. The phase conversion component 230a may include a mechanism for compressing the porous wicking material to extract the liquid phase of the propellant. In some implementations, the phase conversion component includes an expansion nozzle, a rapid valve, a heating section and/or another suitable mechanisms for evaporating the propellant to fully convert the propellant to gas. In some implementations, the phase conversion component 230a directs the gas propellant to the outlet line 240a. In other implementations, the phase conversion component 230a includes a section for fully condensing the evaporated propellant and directing the all-liquid propellant to the supply line 240a.

FIG. 2B illustrates another configuration, where the two-phase intake component 220b is disposed within the tank 210b. For example, the two-phase intake component 220b may be an impeller. The impeller may be configured to use centrifugal phase separation to preferentially supply the liquid phase of the propellant to the phase conversion component 230b. The two-phase intake component may also include a section of porous wicking material, as described above.

In FIG. 2C, the configuration with both the two-phase intake component 220c and the phase conversion component 230c disposed within the tank 210c. For example, the two-phase intake component 220c may include a section of porous wicking material disposed within the tank. The phase conversion component 230c may be a mechanism, disposed within the tank for extracting the liquid phase of the propellant.

FIG. 3 illustrates an of a propellant management system (e.g., the propellant management system 200a) for converting a two-phase mixture of propellant from a tank 310 into a single phase using a piston pump 320. A tank 310 may be the tank 210a, fluidicly coupled to an outlet line 350. Valves 330a and 330b are disposed in the outlet line 350 upstream and downstream, respectively, of the piston pump 320. A controller 340 controls each of the valves 330a and 330b as well as the piston pump 320. In particular, the controller 340, first causes the valve 330a to open to thereby cause the mixture of the liquid to reach the piston pump 320. Subsequently, the controller 340 causes the valve 330a to close, while the valve 330b remains closed. The controller 340 further causes the piston pump 320 to compress the mixture of phases of the propellant, thereby causing the gaseous propellant to condense. The controller 340 then opens the valve 330b directing the liquid propellant to the outlet line 350.

In some implementations, a cooler (e.g., a thermoelectric cooler) may cool the propellant in a section of the outlet line 350 between the propellant tank 310 and the valve 330a.

In a sense, the components of FIG. 3 implement the two phase intake component 220a and the phase conversion component 230a. Other example implementations of the two phase intake component 220a-c and the phase conversion component 230a-c are discussed in the context of FIGS. 9-18.

FIG. 4A illustrates a system for controlling a volume flow rate of a two-phase mixture from a tank 410 based on a sensor 430 for detecting a composition of the two-phase mixture. The tank 410 is fluidicly coupled to a two-phase intake component 420 via a line 412. The two-phase intake component 420 is configured to remove propellant from the propellant tank 410 with a variable volumetric flow rate. The sensor 430 is configured to determine the composition of the flow (e.g., a ratio of liquid volume to gas volume) in the section of the line 412 between the tank 410 and the two-phase intake component 420 and/or generate a signal indicative of an amount of liquid in the mixture. A controller 440a may vary the flow rate of the two-phase intake component 420 based at least in part on the signal generated by the sensor 430. The sensor 430 may be an optical sensor, a capacitive sensor, or any other suitable sensor.

In some implementation, the sensor 430 and/or the two-phase intake component 420 may be disposed within the tank 410. The two-phase intake component 420 may be an impeller.

FIG. 4B illustrates another implementation of the system for controlling a volume flow rate of a two-phase mixture from a tank 410. The system includes a sampling pump 432 fluidicly connected to the propellant tank 410 via a line distinct from the line connecting the tank 410 and the two-phase intake component 420. The sampling pump 432 in configured to collect a volumetric sample of the propellant mixture. The system in FIG. 4B further includes a sensor 434, communicatively connected to the controller 440a, and configured to detect the amount of liquid in the volume of the sample. The sensor 434 may then generate a signal indicative of the amount of liquid and/or the ratio of liquid to gas in the sample and communicate the signal to the controller. The controller 440a may vary the flow rate of the two-phase intake component 420 based at least in part on the signal generated by the sensor 434. The detection process of the amount of liquid in the sample using the sensor 434 may consume the sample.

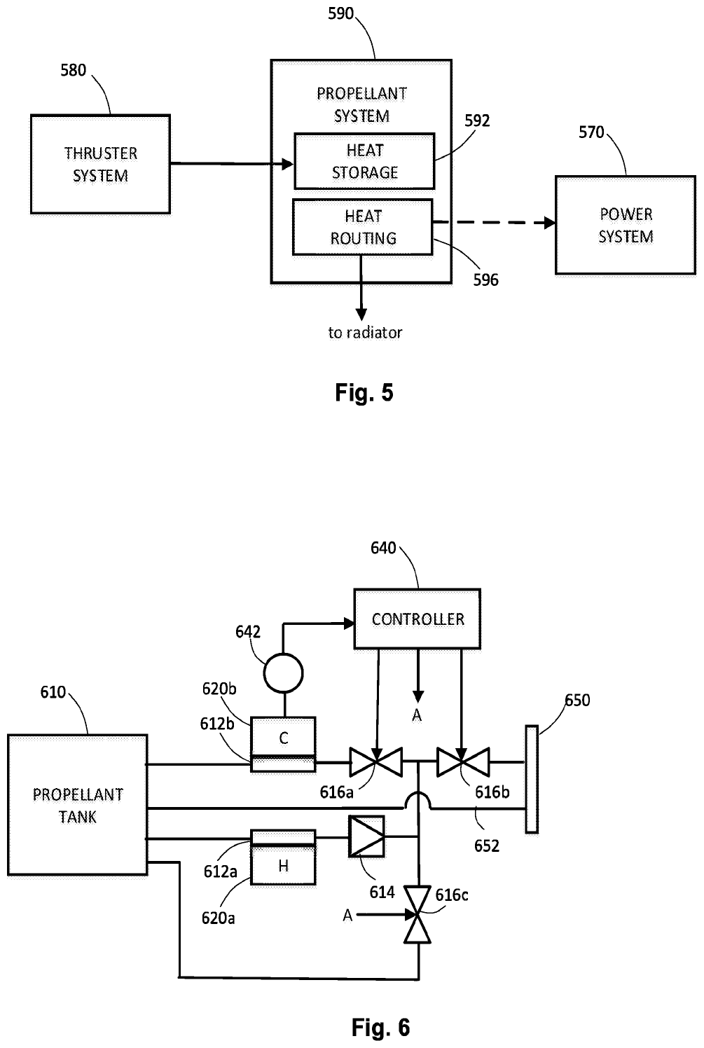

FIG. 5 illustrates a general architecture of using a propellant system for managing heat in a spacecraft. The architecture for managing heat using propellant may thermally and/or fluidicly connect a thruster system 580 (e.g., the thruster system 180), a propellant system 590 (e.g., the propellant system 190) with heat storage components 592 and heat routing components 592, and, in some implementations, a power system 570 (e.g., the power system 170). In some implementations, the thruster system contains a MET thruster configured to consume propellant to generate thrust. The MET thruster includes a microwave source (e.g., including a magnetron) that, in operation, generates excess heat in the thruster system 580. A resonant cavity of the MET thruster may generate additional access heat. The propellant system 590 may use propellant to transfer the access heat away from the thruster system 580 using a heat exchanger and store it in the heat storage elements 592 that may include propellant stored in a tank. In some implementations, the heat storage elements 592 of the propellant system 590 may include a dedicated heat storage tank (e.g., for storing a heated amount of propellant as superheated steam).

The routing elements 596 of the propellant system 590 may direct the excess heat (i.e., the heated propellant) to a subsystem of the spacecraft. In some implementations, the routing elements 596 may direct the heat to a radiator. In other implementations, the subsystem of the spacecraft receiving the excess heat is the power system 570. The power system may include thermal generators, turbines, or other suitable components for converting excess heat to electricity. Additionally or alternatively, the subsystem of the spacecraft receiving the excess heat is the thruster system 580. For example, a portion of the heated propellant steam may be directed to the MET thruster to generate thrust.

FIG. 6 illustrates an example implementation of using a propellant system for managing heat in a spacecraft by pumping propellant through one or more heat exchangers. A propellant tank 610 may be fluidicly coupled to heat exchangers 612a and 612b, that are in thermal connection with respective components 620a and 620b, and, through pump 614, and/or valves 616a,b to the radiator 650. The radiator may include a conduit for the propellant, so as to allow a fluidic connection to the tank 610 downstream of the pump 614 via the radiator return segment 652. A controller 640 may direct the propellant exiting the pump 614 by opening and/or closing the valves 616a, 616b, or 616c. The heat exchanger 612a may be in thermal contact with a component 620a that is at a higher temperature than the propellant in the heat exchanger 612a. Consequently, the propellant passing through the heat exchanger 612a may absorb heat while cooling the component 620a. In some implementations, the component 620a may be a microwave source (e.g., including a magnetron) for a MET thruster. The pump 614 may cooperate with at least one of the valves 616a-c to direct the heated portion of the propellant to a heat sink. For example, the controller 640 may open (i.e., cause to open) the valve 616c to direct the heated propellant to the propellant tank 610. Alternatively, the controller 640 may open the valve 616b to direct the propellant to the radiator 650, thereby directing the excess heat from the component 620a to the radiator 650 that may be thermally connected to a conduit for the propellant. The propellant, having transferred the heat to the radiator 650, may return to the tank 610 via the line segment 652. In some implementations the radiator 650 may be expandable, and may expand in response to the flow of the heated propellant.

Still alternatively, the controller 640 may open the valve 616a, cooperating with the pump 614 to direct the heated propellant to the heat exchanger 612b for transferring the heat the component 620b that may act as a heatsink. In some implementations, the component 620b is a power plant (e.g., including a turbine or a thermoelectric generator) configured to generate electricity. In some other implementations, the component 620b is a spacecraft component that requires a heat input. In some implementations, a sensor 642 may detect the temperature of the component 620b and generate the signal indicative of the temperature for the controller 640. The controller 640 may cause the routing of the heated propellant to the exchanger 612b in response to the signal from the sensor 642. For example, the signal 642 may indicate that the component 620b temperature is below a threshold value and causing the controller 640 to cause the routing of the heated propellant to the exchanger 612b.

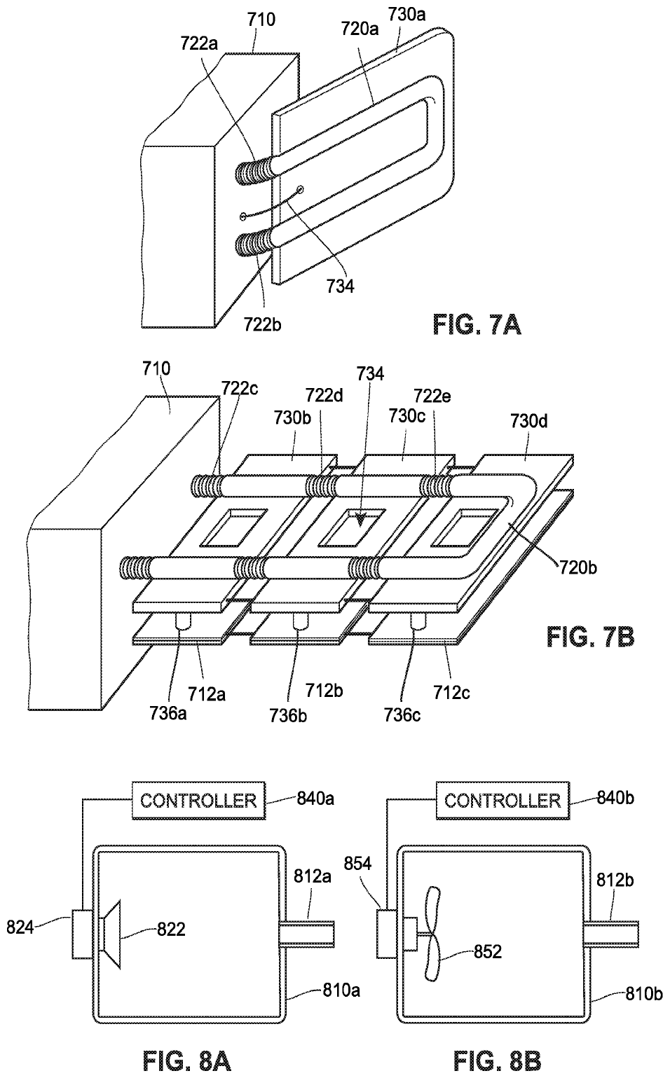

FIG. 7A illustrates a deployable radiator 730a disposed outside of a spacecraft housing 710 and thermally connected to a propellant conduit 720a with two flexible sections 722a,b. the flexible sections 722a,b enable the mechanism 734 to deploy the radiator 730a. In operation, heated propellant, as discussed in the context of FIG. 5 and FIG. 6 may flow through the conduit 720a of the radiator 730a to transfer heat from heated propellant to the radiator 730a.

FIG. 7B illustrates a radiator composed of radiator sections 730b-d disposed outside of the spacecraft housing 710 in an implementation alternative to the one illustrated in FIG. 7A. The radiator sections 730b-d of a radiator are attached, correspondingly, to sections 712a-c that constitute a solar array. The radiator is attached to a back side of the solar array via stand-offs 736a-c and thermally connected to a propellant conduit 720b. The conduit includes flexible sections 722c-e with additional flexible sections not labeled to avoid clutter. As in the context of FIG. 7A, heated propellant may flow through the conduit 720b to transfer heat from heated propellant to the radiator composed of sections 730b-d. The sections 730b-d of the radiator may include openings, such as a window 734 to facilitate radiation by the backside of the solar array.

As discussed in the context of FIG. 6, a pump may direct the heated propellant through the conduit 720a or the conduit 720b.

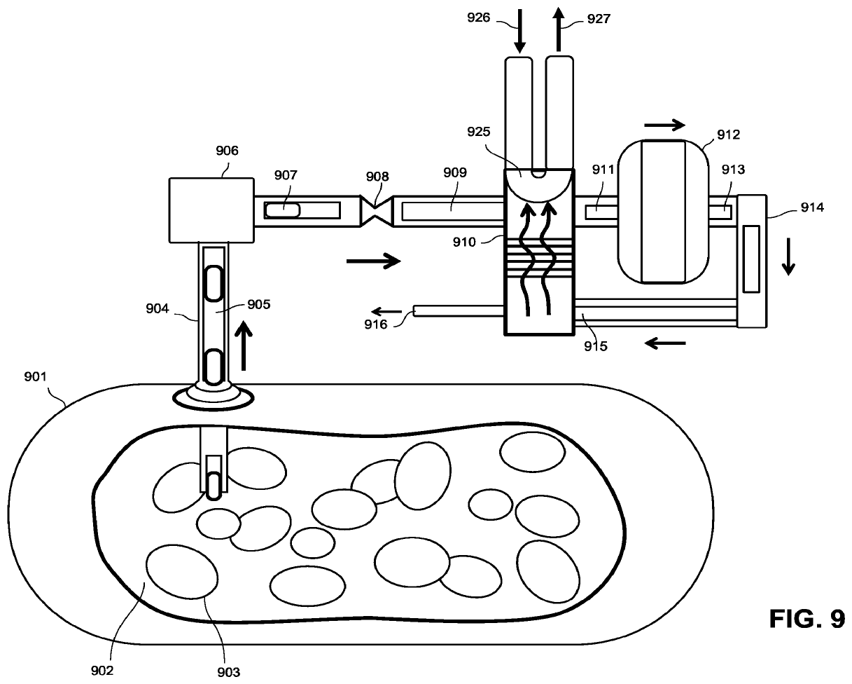

FIGS. 8A and 8B describe structure and operation of example implementations of the mixers 212a-c in FIGS. 2A-C.

FIGS. 8A and 8B illustrate systems for storing propellant in microgravity comprising corresponding tanks 810a and 810b fluidicly coupled to corresponding outlets 812a and 812b. The tank including an ultrasonic transducer acting as an agitator for increasing circulation of a mixture of liquid and gas in microgravity.

The tank 810a includes an ultrasonic transducer 822 configured as an agitator for increasing circulation of the mixture of liquid and gas propellant stored in the tank 810a in microgravity. The ultrasonic transducer 822 may be driven by an ultrasonic voice coil 824 controlled by a controller 840a. The ultrasonic transducer 822 may be configured to transduce ultrasonic vibrations directly to the mixture of liquid and gas. In other implementations, the ultrasonic transducer 822 may be configured to transduce ultrasonic vibrations to the walls of the tank 810a, shaking the drops agglomerated at the walls. In the latter case, the ultrasonic transducer 822 may be disposed outside of the tank 810.

The tank 810b includes a fan 852 configured as an agitator for increasing circulation of the mixture of liquid and gas propellant stored in the tank 810b in microgravity. The fan 852 may be driven by a motor 853 controlled by a controller 840a.

The controllers 840a,b may activate the corresponding ultrasonic transducer 822 and the fan 852 in response to composition of the mixtures inside the tanks 810a and 810b. For example, the controllers 840a,b may turn on or increase the drive when the volume fraction of liquid propellant to gaseous propellant decreases in the tanks 810a,b.

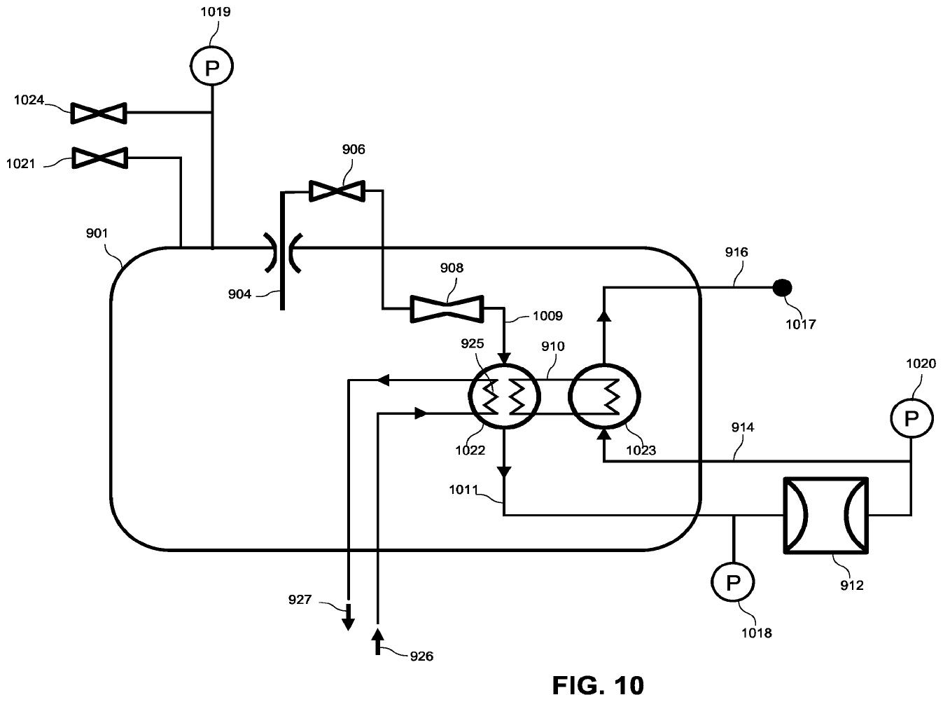

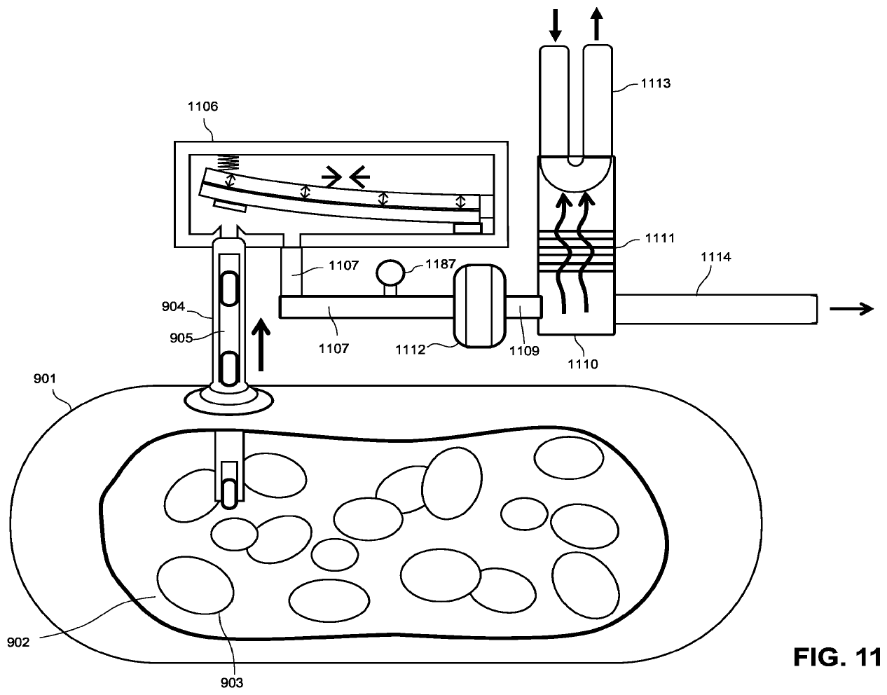

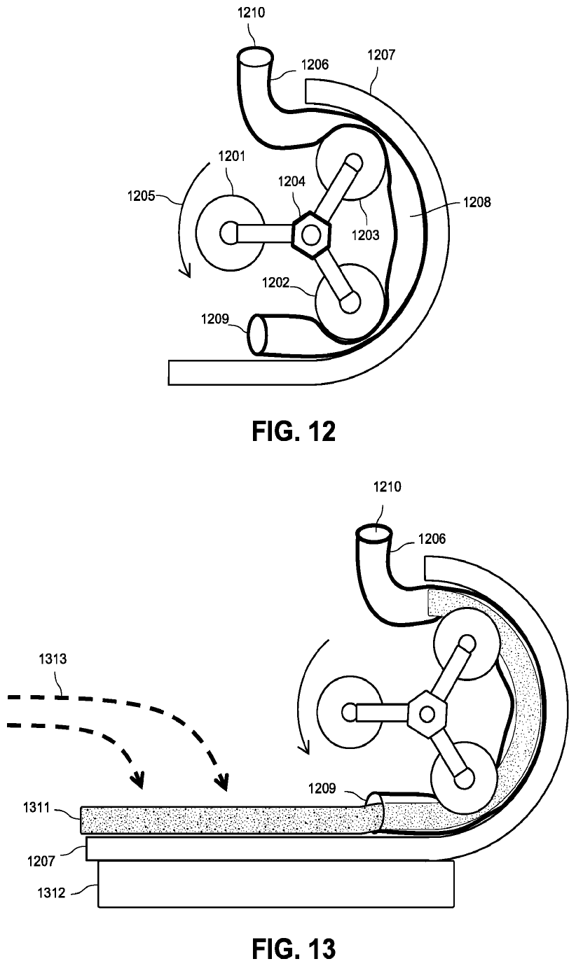

Additional examples of techniques and implementations discussed above are presented below. With FIGS. 9-19, the discussion returns to example implementations of two-phase propellant management systems. FIGS. 9-11 can be thought of as illustrations of implementations of the systems and methods discussed in relation to FIG. 2A. In particular, FIGS. 9-10 illustrate a system that uses flash evaporation (by pumping a phase-mixed fluid through a restriction) and a heat exchanger to convert propellant to a liquid form. FIG. 11, on the other hand, illustrates a system that uses a rapidly-actuated valve to break up the flow of the mixed-phase propellant. The valve may be controlled to maintain mass flow rate in view of a variable fraction of liquid in the flow. FIGS. 12-19 illustrate a number of techniques for using capillary action and/or peristaltic pumping for propellant management. These techniques may be used to implement the propellant management system configurations discussed in relation to FIGS. 2A-C.

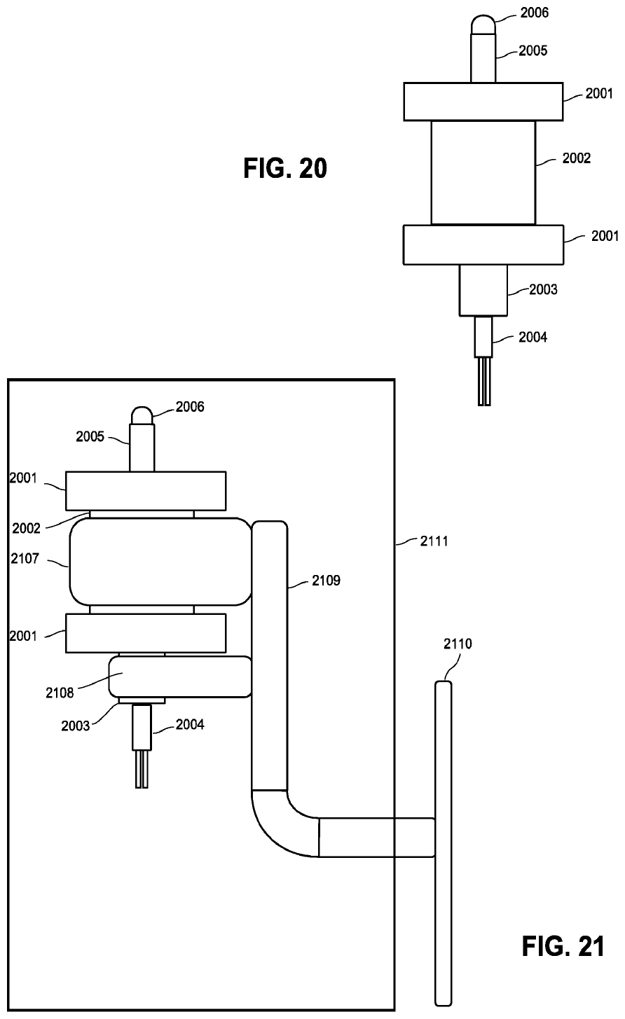

FIGS. 20-22 illustrate aspects of a thermal management system that may use propellant and generally relate to the systems and methods discussed with respect to FIGS. 5-7. Specifically, the techniques discussed with respect to FIGS. 20-22 relate to using a heat pipe (e.g., with the propellant) for cooling a magnetron that is a part of a thruster system.

FIG. 9 is a cutaway view illustrating components of a system for converting a mixed-phase propellant flow to an all-liquid propellant. To avoid clutter, FIG. 9 omits the various tubes and valves required to initially fill the container with fluid, and various pressure sensors, and all electrical connections to pumps and valves. The system includes a tank 901 (that may be the tank 210a, for example), that may also be referred to as a pressure chamber. In a microgravity environment, the tank 901 may contain a propellant (or another useful fluid) as a mixture of two components: a gas vapor 902 and liquid drops 903. In the absence of gravitational forces, liquid phase gathers into drops 903 due to liquid surface tension. The drops 903 freely float around within the tank 901 or may attach, at least temporarily, to the tank walls. The drops 903 may be separated from the tank walls and each other by the surrounding gas vapor 902.

As shown in FIG. 9, an extraction tube 904 (a tube represents any suitable fluidic connection) with a channel 905 may penetrate a wall of the tank 901 for the purpose of withdrawing propellant on demand (e.g., a signal from the propulsion control unit 140). A valve 906 may open, allowing a pump 912 (e.g., a vapor pump) to draw or take in fluid propellant into the extraction tube 904. When the propellant in the tank 901 is a mixture of phases, the propellant drawn into the extraction tube 904 may be a train of liquid segments (e.g. liquid segment 907) separated by gas. In a sense, the gas separating liquid segments can be thought of as gas bubbles in a liquid stream of propellant. In the manner described, the pump 912, in cooperation with the extraction tube 904 may take in either vapor or liquid phase of the propellant from the tank 901. The take-in process may be limited by the pressure within the tank 901 falling below the minimum working pressure of the pump 912. By continuing the pumping action down to the minimum pumping pressure of the vapor pump 912, the described system may substantially empty the tank 901. After passing through the valve 906, the mixture of liquid and gas bubbles is forced through a restrictor 908 (e.g., a throttle valve, a Joule-Thompson valve, etc.). The suitably sized restrictor 908 may provide a substantial pressure drop between the mixed-phase fluid coming in and the output fluid. The abrupt adiabatic pressure drop may cause any liquid bubbles in the fluid to be flash evaporated to vapor 909 and the vapor temperature may fall substantially in accordance with the Joule-Thompson Effect (as used, for example, in refrigeration methods).

The cooled vapor 909 then passes through the warm side of a heat exchanger 910 (i.e., an evaporator) where the vapor propellant is partially warmed. Excess heat from the evaporator is conducted to an external cooling loop 925 which is provided with an input flow 926 of a cooling fluid and an output flow 927. The warmed vapor 911 may enter the pump 912. By compression in the pump 912, the vapor is further heated. The compressed and heated vapor 913 then passes through tubes 914 until, at a condenser inlet 915, the propellant enters the cool side of the heat exchanger 910 (i.e., a condenser).

As the compressed vapor is cooled, it condenses to the liquid phase of the fluid. The resulting bubble-free liquid is delivered through an output tube 916 from where the propellant may be metered and delivered to a delivery point for its intended end use (e.g., by the thruster feeds 250a-c).

FIG. 10, is a schematic (and more detailed) view of the system architecture for the system illustrated in FIG. 9. Like reference numbers refer to identical components in FIG. 9. The tank 901 contains a propellant (or another useful fluid) which may be in a mixture of liquid and gaseous vapor phase. The tank wall may be penetrated by an extraction tube 904 for the purpose of withdrawing the propellant on demand (e.g., in response to a control signal from the propulsion control unit 140). When the pump 912 is pumping and when the valve 906 is open, pumping action may cause fluid to be drawn into the extraction tube 904 and through the valve 906.

Following valve 906, the mixture of liquid and gas bubbles may be forced through a restrictor 908. The restrictor may be sized to provide a substantial pressure drop between the mixed-phase fluid at its input and the cooled vapor tube 1009 at the output. The cooled vapor tube 1009 then passes through an evaporator 1022 (i.e., the warm side of heat exchanger 910) where the vapor is partially warmed. The warmed vapor tube 1011 leads to the vapor pump 912. By compression in the vapor pump 912, the vapor is further heated. The compressed and heated vapor 913 then passes through the tubes 914 until, at the inlet 915 it enters a condenser 1023 (the condenser side of the heat exchanger 910). The heat evaporator 1022 side of the heat exchanger 910 includes the cooling loop 925 which is supplied with the cooling fluid flows 926 and 927. As the compressed vapor is cooled, it condenses to the liquid phase of the fluid. The resulting bubble-free liquid propellant (or another useful fluid, generally) may exit through the output tube 916 to an outlet point 1017, connected, for example, to a thruster feed.

Sensors 1018, 1019, 1020 may monitor pressure conditions throughout the system. Valves 1021 and 1024 may be used to fill and empty the tank 901 with fluid as needed.

FIG. 11 is a cutaway view illustrating components of another system for converting a mixed-phase propellant flow to an all-liquid propellant. To avoid clutter, FIG. 11, like FIG. 9, omits the various tubes and valves required to initially fill the container with fluid, and various pressure sensors, and all electrical connections to pumps and valves. Some of the elements of FIG. 11 are the same as those illustrated in FIG. 9, and are labeled, accordingly, with the same reference numbers.

In FIG. 11, the tank 901, as in FIG. 9, may contain propellant (or another useful fluid) as the mixture of two components: the gas vapor 902 and the liquid drops 903. As shown in FIG. 9, the extraction tube 904 with the channel 905 may penetrate a wall of the tank 901 for the purpose of withdrawing the propellant (e.g., based on a signal from the propulsion control unit 140). Though pump 1112 may be the same as the pump 912, a fast-acting valve 1106 is different from the valve 906 of FIG. 2.

The fast acting valve 1106 repeatedly interrupts the fluid flow as it moves from the channel 905 of the tube 904 and into connecting low pressure tubes 1107 (or another suitable low-pressure fluidic channel and/or vessel with a low pressure volumetric region). The pump 1112 (e.g., an electrically powered vapor-phase pump) may maintain the low pressure in the tubes 1107. The fast-acting valve 1106 may actuate to divide the flow of fluid into a series of pulses of fluid. Each pulse of fluid may be of sufficiently small volume such that the any liquid phase portion of the pulse will be flash evaporated as it enters the low pressure tubes 1107 or any suitable low pressure volumetric region. The valve may be actuated using piezo-electric actuation.

A pressure sensor 1108 may detect the pressure in the low pressure tubes 1107. The pressure sensor may be connected to a controller (not shown). The controller may open or close the valve 1106 in response to the detected pressure. The evaporation of a pulse of liquid may increase the pressure and/or lower the temperature of gas in the low pressure tubes 1107 due to well know gas dynamic principles. The rapid increase in pressure may be subsequently reduced by pumping action of the pump 1112 as vapor is removed from the low pressure tubes 1107. The controller may measure the pressure rise and fall. When the pressure returns to a suitable low value, the controller causes the fast acting valve 1106 to pass another pulse of fluid.

After passing through pump 1112, the now compressed and warmed propellant in vapor phase in tube 1109 enters a cooled condenser 1110 portion of a heat exchanger where it may be condensed to liquid phase. The condenser 1110 may be cooled by contact with a thermoelectric heat pump 1111. Heat from the heat pump 1111 may transfer to an external cooling loop 1113 (analogous to the cooling loop 925). The cooled and condensed liquid-phase propellant enters an output tube 1114, from where it can enter a thruster feed or be used in another capacity (e.g., thermal management, as discussed above).

FIGS. 12-19 illustrate systems and methods for management of a useful fluid (e.g., propellant) using capillary action. In such systems, a low density vapor-phase of a fluid may be caused to condense onto a cooled complex surface at a temperature below the dew point of the fluid, but above the freezing point. The complex surface may be composed, for example, of loosely packed hydrophilic fibers. The term “hydrophilic” is used in the sense that the liquid phase of a useful fluid readily wets and adheres to a surface. The condensed fluid, now in liquid phase, is drawn into the interstitial spaces between the fibers by capillary action resulting from surface tension effects between the fluid and the hydrophilic fibers. The fibrous material functions as a sponge or a wick and may be termed a wicking material.

As the fluid moves through the wicking material, it may enter a positive displacement peristaltic pump. The pump periodically squeezes the wicking material into a smaller volume, thus pressurizing the nearly incompressible liquid and driving it out of the collapsing interstitial spaces. The resulting free fluid may be forced through a check valve and into an output tube. The process is similar to hand-squeezing a wet sponge. In this manner, the pump is able to overcome the capillary forces which draw the fluid along the wick.

Furthermore, the pump may deliver the pressurized fluid at a pressure greater than the vapor pressure of the fluid at its present temperature, thereby preventing the formation of vapor bubbles. After extracting a portion of the available liquid fluid, the pump releases pressure on the wicking material. The arrival of fresh fluid by capillary action from the condensing surface may cause the wick to expand to its original volume. The process may be repeated as often as condensation can replace the extracted liquid.

FIG. 12 illustrates an example peristaltic roller pump. Rollers 1201, 1202, and 1203 are driven in a circular arc around a common hub 1204 in a direction shown by curved arrow 1205. The rollers compress a flexible collapsible tube 1206 against a circular base plate 1207. In the illustrated implementation, the flexible compressible tube 1206 has a substantially round cross section in its uncompressed state. Fluid enters the pump at an input port 1209. A fixed section 1208 of the tube 1206 is captured between the rollers 1202 and 1203. Both liquid and vapor may be captured in the fixed volume. The contents of volume 1208 are forced around the curved path to the output port 10 of the pump. The process repeats between successive pairs of rollers.

The peristaltic pump is a positive displacement pump which can pump mixed liquid and gas fluids. The term “peristaltic” refers to pumping by compressing a tube in a wave that propagates down the tube. Peristaltic pumping is common in biological systems such as the human esophagus.

Referring to FIG. 13, a length of compressible wicking material 1311 is inserted into the compressible tube 1206. The circular base plate 1207 is extended to the left with a straight section beyond the input port 1209 of the pump. Similarly, a portion of the wicking material 1311 extends outward from the pump input port 1209 and may be in thermal contact with the straight section of the base plate 1207. Base plate 1209 is further in thermal contact with cold plate 1312, which may be temperature controlled by a thermoelectric cooler (not shown). The temperature of the cold plate 1312 is adjusted to keep wicking material 1311 at a temperature lower than the dew point but higher than the freezing point of a desired fluid 1313 to which the cooled wicking material 1311 may be exposed. The pressure-saturated vapor phase of the desired fluid 1313 may, consequently, condense to liquid phase upon the cold surface of the wicking material 1311 in the same manner as atmospheric water may condense as dew upon a cold surface during weather conditions of high humidity. The now liquid-phase fluid is drawn into the interior of the wicking material by capillary action. The liquid is further drawn by capillary action into the input port 1209 of the roller pump as hydrostatic pressure forces the fluid from regions of higher concentration to lower concentration.

When the wicking material at the pump input port 1209 reaches a saturation level of entrained fluid, the roller pump is actuated to capture the fixed volume 1208 of the flexible tube 1206. By progressively compressing the wicking material against the circular arc of the base plate 1207, liquid is pressurized and forced to the output port 1210.

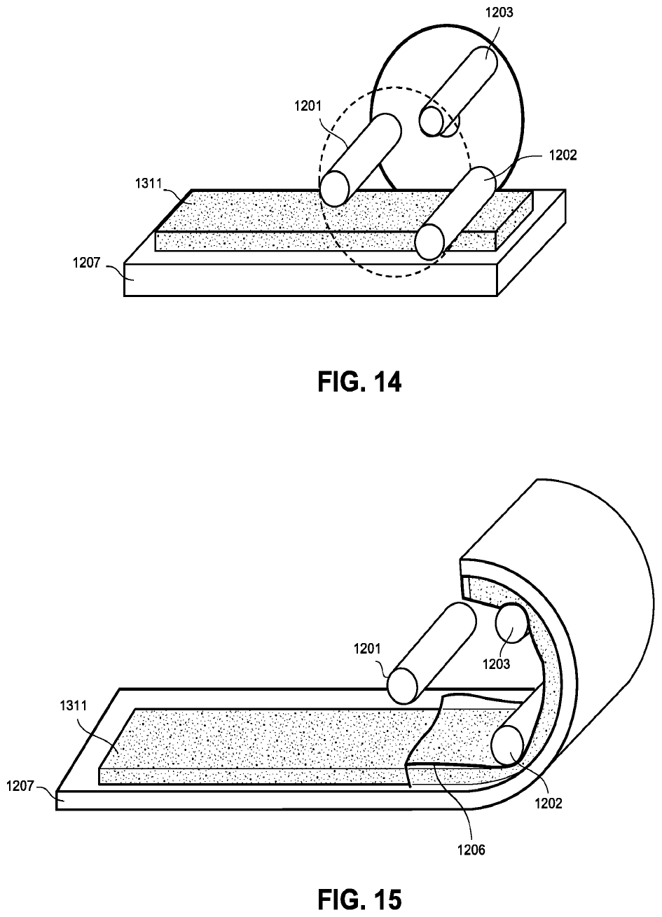

FIG. 14 is a perspective illustration of certain components of a roller pump which is designed for wide area wicks. The pump rollers 1201, 1202, and 1203 are extended along their axial directions to accommodate wider wicking material 1311. In this manner, the surface area of wick in contact with base plate 1207 and the surface area available for vapor condensation may be increased, thereby increasing the rate of fluid conversion to the liquid phase and increasing pumping throughput.

FIG. 15 further illustrates certain additional components of a wide roller pump. In this figure, the compressible tube 1206 has been widened to accommodate a wider wick 1311. In this case, tube 1206 need not have a continuous circumference. The sides of tube 1206 may be connected directly to the cooled base plate 1207. The fluid-saturated wicking material 1311 may be compressed directly against the curved portion of the cooled base plate 1207 for improved thermal contact between the wick and base plate.

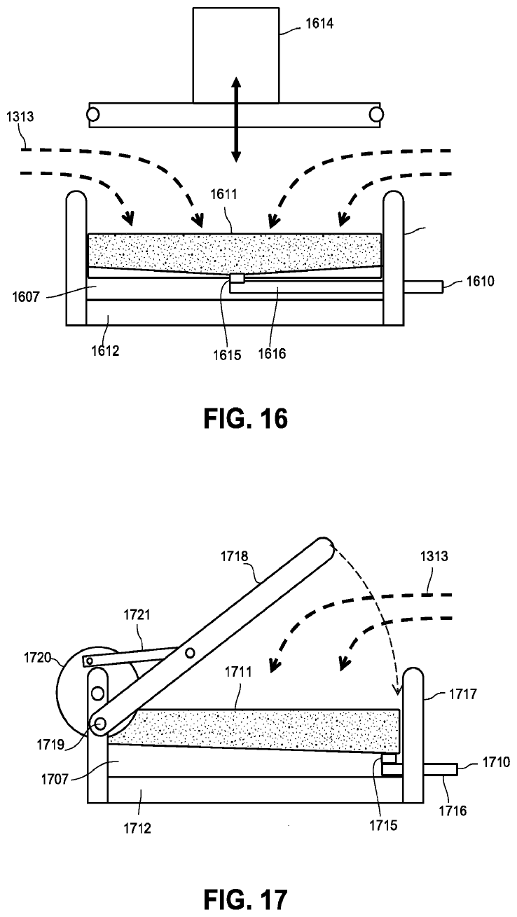

FIG. 16 illustrates a peristaltic piston pump. In this embodiment, all components may have cylindrical symmetry. The figure illustrates a cross section of the components. A base plate 1607 (analogous to the base plate 1207) is moderately tapered in thickness toward a central drain hole. As in some other embodiments, the base plate 1607 is in thermal contact with cold plate 1612 (analogous to the cold plate 1212). Wicking material 1611 (analogous to the wicking material 1211) is in thermal contact with the base plate 1607.

When a piston 1614 is withdrawn to an upper position, ambient fluid vapor 1313 may condense across the entire surface of the wick 1611. When the piston 1614 is lowered, it compresses the entire volume of the wick 1611, thereby driving liquid into a drain hole 1615 and, possibly, through a small check valve (not shown). The pressurized liquid flows through the drain tube 1616 to an output port 1610. The wicking material 1611 and the piston 1614 are fit closely between cylinder walls 1617 to prevent fluid from excessively escaping around the piston 1614. The cylinder walls 1617 may be constructed of thermally insulating material, such as plastic or ceramic. The cylinder walls 1617 may be thermally isolated from the cold plate 1612 and be kept at a temperature above the dew point to prevent liquid from condensing on the outside of the cylinder. In this embodiment, capillary action may not be required to transport fluid from the condensing portion of the wick into the pumping mechanism, which may result in improved pumping efficiency over other embodiments.

FIG. 17 illustrates a hinged plate peristaltic pump. In this embodiment, all components may be rectangular in shape. When a hinged plate 1718 is in the raised position, ambient fluid vapor 1313 may condense across the entire surface of the wick 1711 (analogous to the wicks 1312, 1611). When the hinged plate 1718 is moved into the closed position, it compresses the entire volume of the wick 1711 cooled by a cold plate 1712, thereby driving liquid into a drain hole 1715 in a base plate 1707 and through a small check valve (not shown). The pressurized liquid flows through drain tube 1716 to an output port 1710 through a wall 1717. The hinged plate 1718 may be articulated about pivot 1719. A motor 1720 in mechanical communication with the drive arm 1721 may periodically raise and lower the hinged plate 1718 to compress the wicking material 1711.

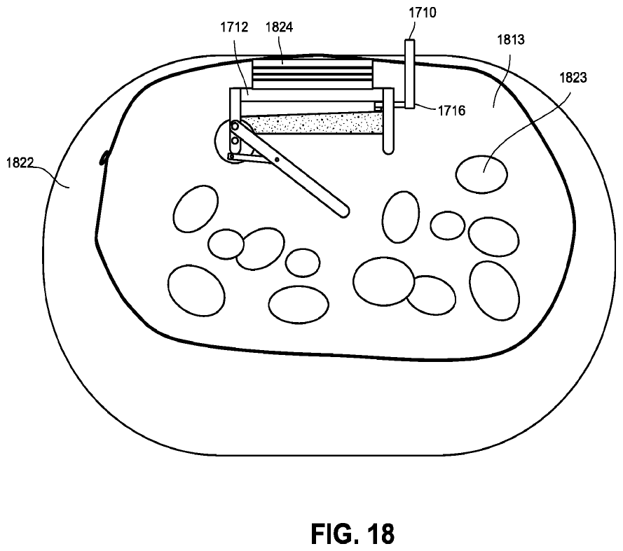

FIG. 18 illustrates a hinged plate peristaltic pump, as illustrated in FIG. 17, which has been installed inside a closed pressure vessel 1822 (e.g., tank 210a-c or tank 901). The pump drain tube 1716 and output port 1710 are shown at the top of the figure where they penetrate the vessel wall. In this embodiment, the cold plate 1712 for the peristaltic pump is cooled by a thermoelectric heat pump 1824. The heat pump 1824 draws heat from the cold plate 1712 and adds heat to the wall of the vessel 1822. In this manner, the vessel 1822 and both its liquid-phase fluid 1823 and its vapor-phase fluid 1813 are slowly warmed during the process of withdrawing fluid through the pump drain tube 1716. As the fluid is warmed, its vapor pressure increases, thereby improving the pumping efficiency of the peristaltic pump.

At the start of a mission, the closed vessel 1822 is initially filled completely with liquid phase fluid 1823. During operations to extract and use the fluid, pressure in the vessel 1822 may be reduced. In spacecraft operations and in many terrestrial applications, it may be preferred to not introduce replacement gasses into the vessel, which might otherwise be used to mitigate the pressure drop. Also, in the vacuum environment of space operations, there may be no external atmospheric pressure acting upon a collapsible vessel to cause it to collapse as fluid is withdrawn. Any internal pressure in the vessel will be sufficient to maintain its shape even as the pressure is reduced from its initial filling. Thus, fluid extraction from a vessel 1822 of constant volume will eventually lead to a vessel partially filled with liquid phase fluid 1823 and partially filled with saturated vapor phase fluid 1813. In a microgravity environment, the liquid phase 1823 gathers into drops due to liquid surface tension. The drops freely float around within the pressure vessel and may be separated from the vessel walls and from each other by the surrounding gas vapor. The capillary action pumps described in FIG. 18 and the other figures discussed above can capture either vapor phase or liquid phase fluid. Fluid of either vapor or liquid phase may be withdrawn from the container until the container pressure has been reduced to the minimum working pressure of the capillary action pump. In this manner, the container may be substantially emptied.

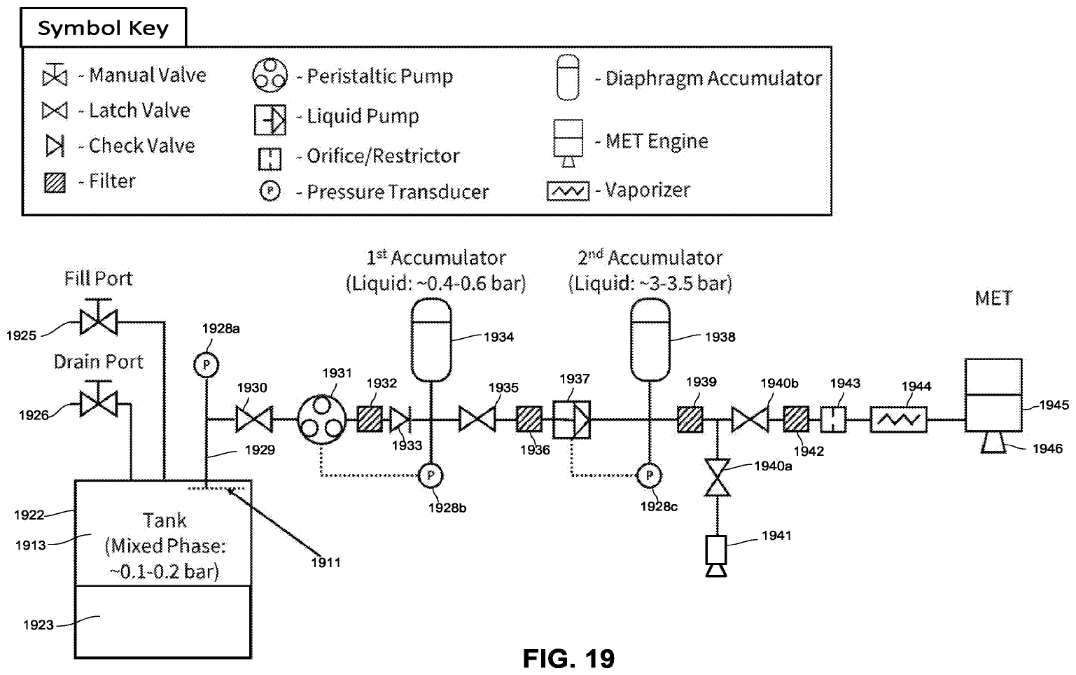

FIG. 19 is a schematic diagram of an embodiment for propellant management in a spacecraft system. In this embodiment, the fluid stored in a tank or vessel 1922 (e.g., tank 210a-c, 901, or vessel 1822) is water. Water may be used as a gaseous propellant for several electrically powered engines on board the spacecraft. A vessel 1922 of constant volume is partially filled with liquid phase water 1923 and partially filled with saturated vapor phase water 1913. A fill port 1925 and a drain port 1926 may be used to completely fill the vessel 1922 prior to launch. Both liquid phase and vapor phases may be extracted from the vessel 1922 by cooled condensing surface 1911. The key feature of the condensing surface 1911 is that all fluid leaving the surface will be completely liquid water. The liquid then passes consecutively through tubing 1929, valve 1930, low pressure pump 1931, particle filter 1932, and check valve 1933 into a first liquid accumulator 1934. The accumulator 1934 may be a relatively small pressurized container with a flexible diaphragm that maintains a constant and relatively low positive pressure on the liquid. The accumulator's 1934 function is to prevent cavitation and the formation of vapor bubbles within the liquid stream. Fluid pressure is measured by various pressure sensors 1928a-c. The measured pressures are used to control the pumping speed of the low pressure pump 1931 and a high pressure pump 1937 to prevent cavitation at all points within the liquid stream. To avoid visual clutter, the system control computer and various sensor and control lines are not shown.

From the first accumulator 1934, liquid flows consecutively through valve 1935, filter 1936, and the high pressure pump 1937 into a high pressure second liquid accumulator 1938. Liquid leaves accumulator 1938 and passes through filter 1939 and then into several valves 1940a-b, that pass the propellant liquid to various electrically powered thrusters. In this embodiment, the valve 1940a passes liquid to one of several small roll control thrusters 1941 as needed. Passing through valve 1940b, a portion of the liquid passes consecutively through a filter 1942 into a restricting orifice 1943. The restriction is sized to control the rate at which water flows into the main propulsion engine 1945. Before entering the engine 1945, the liquid water passes into a heated vaporizer 1944 where it turns to vapor (steam). In this embodiment, the engine 1945 is a MET thruster. In the MET engine 1945, concentrated microwave power creates an electric plasma discharge in the water vapor. The vapor propellant is heated to high temperature and expelled at high velocity through a nozzle 1946 where it produces efficient thrust.

FIGS. 20-22 illustrate aspects of a thermal management system that may use propellant and generally relate to the systems and methods discussed with respect to FIGS. 5-7. Specifically, the techniques discussed with respect to FIGS. 20-22 relate to using a heat pipe (e.g., with the propellant, as discussed above) for cooling a magnetron that is a part of a thruster system.

FIG. 20 schematically illustrates a typical magnetron that includes two magnets 2001, which may be either permanent or electro-magnets. In the case of permanent magnets, it is necessary that cooling be provided to keep the magnet temperatures below the Curie Temperature to prevent permanent demagnetization. The magnets 2001 are disposed at each end of the anode body 2002. Without means for cooling, the anode body 2002 may rise to high temperatures. The anode body 2002 may be the principal source of heat in an operating magnetron. The cathode insulator 2003 surrounds the insulated electric power leads 2004, which provide the electrical power to the magnetron device. The cathode insulator 2003 may be a secondary source of heat and may also need to be cooled during continuous power operation. An insulator 2005 and an antenna cap 2006 may serve to extract microwave power from the anode body 2002 and deliver microwave energy to a useful purpose. Some examples of such useful purposes include: heating of propellants for spacecraft propulsion, long-range communication transmitters, collision avoidance radar systems, heating of asteroid and cometary materials for mining or mineral extraction, ablation of asteroid and comet surface materials for trajectory deflection, and subsurface mapping of celestial bodies such as moons and asteroids. The insulator 2005 and the antenna cap 2006 are not major sources of waste heat and usually do not usually require cooling.

FIG. 21 illustrates a magnetron cooled using a heat pipe system. The anode body 2002 is enclosed by a first cooling jacket 2107 which forms an evaporator portion of a heat pipe system. Similarly, the cathode insulator 2003 is enclosed by a second cooling jacket 2108, which is a second evaporator portion of a heat pipe system. The first and the second cooling jackets 2107 and 2108 may be thermally coupled with a heat transporting conduit 2109 of the heat pipe system. It should be noted that, although heat “pipe” is terminology often associated with similar apparatus, the present system is not limited to a “pipe” and could comprise other structures and conduits, such as large volume chambers used for the temporary storage and/or cooling of volatile liquids and gasses used by the heat management systems of machines and structures which operate in vacuum and/or microgravity environments. The conduit 2109 transports waste heat to a cold condenser 2110 that may be referred to as radiator (e.g., radiator 650, radiator 730a, or radiator with sections 730b-d), which is positioned beyond the outer surface 2111 of a spacecraft or other heat producing construction. The cold condenser 2110 may be shielded from direct solar radiation and can, therefore, efficiently radiate waste heat to distant cold space. The first and the second cooling jackets 2107 and 2108, which are evaporators, along with conduit 2009 and the cold condenser 2010 constitute an integrated heat pipe system.

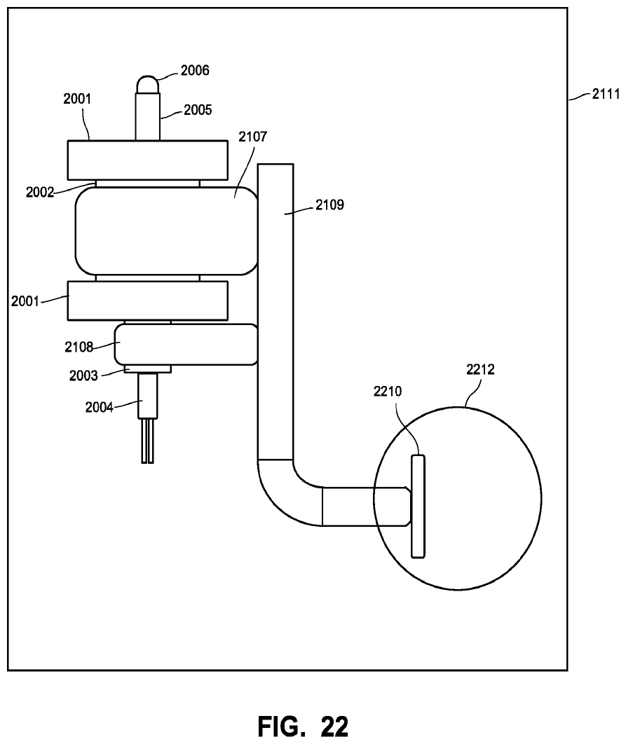

FIG. 22 illustrates a magnetron cooled using a heat pipe system with the heat delivered to an interior surface of a spacecraft. The anode body 2002 and the cathode insulator 2003 are similarly connected to first and second cooling jackets 2107 and 2108, as in FIG. 21. The conduit 2109 transports waste heat to cold condenser 2210, which is disposed within a structure 2212 which is interior to the outer surface 2111 of a spacecraft or other heat-producing construction. The structure 2212 may be any suitable interior structure which requires heat (e.g. power system 570, component 620b, etc.). In certain embodiments, such internal structures would comprise liquid storage tanks otherwise susceptible to freezing, temperature sensitive lubricants for moving parts, or life support systems for biological occupants.

The following list of aspects reflects a variety of the embodiments explicitly contemplated by the present disclosure.

Aspect 1. A method for managing propellant in a spacecraft, the method comprising: storing propellant in a tank as a mixture of liquid and gas; transferring the propellant out of the tank; converting the mixture of liquid and gas propellant into a single phase, where the single phase is either liquid or gaseous; and supplying the single phase of the propellant to a thruster.

Aspect 2. The method of aspect 1, wherein converting the propellant into a single phase includes converting the mixture of liquid and gas propellant directly into liquid.

Aspect 3. The method of aspect 2, wherein converting the mixture of liquid and gas propellant directly into liquid includes compressing the propellant using a piston.

Aspect 4. The method of aspect 1, wherein converting the mixture of liquid and gas propellant into the single phase includes converting the propellant directly into gas.

Aspect 5. The method of aspect 1, wherein converting the mixture of liquid and gas propellant into a single phase includes: first converting the mixture of liquid and gas propellant into gas, then converting the gas into liquid.

Aspect 6. A system for managing propellant in a spacecraft, the system comprising: a tank for storing propellant as a mixture of liquid and gas; a two-phase intake device configured to operate at a variable volume flow rate; a sensor configured to generate a signal indicative of an amount of liquid in the mixture of liquid and gas; and a controller configured to vary the variable flow rate of the two-phase intake device based at least in part on the signal generated by the sensor.

Aspect 7. The system of aspect 6, wherein the sensor is disposed at an outlet line of the tank.

Aspect 8. The system of aspect 6, wherein the sensor is disposed within the tank.

Aspect 9. The system of aspect 6, wherein the two-phase intake device is a pump.

Aspect 10. The system of aspect 6, wherein the two-phase intake device is an impeller.

Aspect 11. The system of aspect 6, further comprising: a sampling pump configured to remove a sample of the mixture of the propellant stored in the tank, wherein the signal indicative of the amount of liquid in the mixture of liquid and gas is based at least in part on an amount of liquid in the sample.

Aspect 12. A method for transferring propellant out of a tank that stores the propellant in microgravity as a mixture of gas and liquid, the method comprising: pumping with a two-phase pump a certain volume of propellant via an outlet line; determining, using a sensor, a ratio of liquid and gas in the certain volume; and setting a speed of pumping with the two-phase pump based at least in part on the determined ratio.

Aspect 13. A system for managing heat in a spacecraft, the system comprising: a tank configured to store a propellant; a microwave electro-thermal (MET) thruster configured to consume the propellant to generate thrust, the thruster including a microwave source that, in operation, generates excess heat; and a heat exchanger configured to transfer the excess heat to the propellant stored in tank.

Aspect 14. The system of aspect 13, wherein the microwave source includes a magnetron.

Aspect 15. A method for managing heat in a spacecraft, the method comprising operating a microwave electro-thermal (MET) thruster including a microwave source, wherein operating the MET thruster includes: consuming propellant, and generating excess heat; heating an amount of the propellant using the excess heat; storing the excess heat by storing the heated amount of the propellant in a tank; and directing the excess heat to a subsystem of the spacecraft.

Aspect 16. The method of aspect 15, wherein directing the excess heat to the subsystem of the spacecraft includes: directing the excess heat to a radiator.

Aspect 17. The method of aspect 15, wherein directing the excess heat to the subsystem of the spacecraft includes: directing the excess heat to a power system for converting to electricity.

Aspect 18. The method of aspect 15, wherein directing the excess heat to the subsystem of the spacecraft includes directing the heated amount of the propellant to a thruster.

Aspect 19. A system for managing heat in a spacecraft, the system comprising a tank configured to store a propellant; a microwave electro-thermal (MET) thruster configured to consume the propellant to generate thrust, the thruster including a microwave source that, in operation, generates excess heat; a heat exchanger configured to transfer the excess heat to a portion of the propellant in a conduit, thereby heating the portion of the propellant; and a pump configured to direct the heated portion of the propellant to a heat sink.

Aspect 20. The system of aspect 19, wherein the heatsink is a radiator.

Aspect 21. The system of aspect 20, wherein the radiator is expandable.

Aspect 22. The system of aspect 19, wherein the heatsink is a power plant, configured to generate electricity.

Aspect 23. The system of aspect 22, wherein the power plant includes a thermal generator.

Aspect 24. The system of aspect 19, wherein the heatsink is a spacecraft component that requires a heat input

Aspect 25. The system of aspect 24, further comprising: a sensor, configured to detect a temperature of the spacecraft component; and a controller, configured to direct the heated portion of the propellant toward the spacecraft component based at least in part on the detected temperature.

Aspect 26. A system for managing heat in a spacecraft, the system comprising: a deployable radiator; a conduit having a flexible section and configured for carrying a propellant, the conduit in a thermally conductive connection with the deployable radiator.

Aspect 27. A system for managing heat in a spacecraft, the system comprising: a radiator, disposed at a back side of a solar panel; a conduit having a flexible section and configured for carrying a propellant, the conduit in a thermally conductive connection with the radiator; and a pump configured to pump propellant through the conduit.

Aspect 28. The system of aspect 27, wherein the radiator is attached to the backside of the solar panel with stand-offs, so as to substantially reduce conduction of heat from the solar panel to the radiator.

Aspect 29. A system for storing propellant in microgravity comprising: a tank for storing propellant as a mixture of liquid and gas; and an agitator, configured to increase circulation of the mixture of liquid and gas in microgravity; and a controller configured to activate the agitator.

Aspect 30. The system of aspect 29, wherein the agitator is an ultrasonic transducer.

Aspect 31. The system of aspect 29 disposed within the tank and configured to transduce ultrasonic vibrations directly to the mixture of liquid and gas.

Aspect 32. The system of aspect 29, wherein the agitator is a fan disposed within the tank.

Aspect 33. A method to reverse a liquid-vapor phase separation in fluids contained in microgravity environments, whereby a mixed-phase stream of fluid is first evaporated to complete vapor and then condensed to a complete liquid phase.

Aspect 34. A system operating in a microgravity environment comprising: a pressure vessel to contain a fluid consisting of both liquid and gas vapor phases; pumps and tubing to extract a portion of the fluid from the container into a flowing stream; means to evaporate the liquid component within the flowing stream into vapor; means to condense the vapor-only stream into a liquid-only stream; and means to deliver the liquid flow to a useful output.

Aspect 35. A system of aspect 34 in which: a flowing stream of fluid containing both liquid and vapor phases is made to pass through a restrictive orifice thereby generating an abrupt pressure drop which causes the liquid component to flash evaporate into vapor; and further comprising a warmed evaporator which adds heat to the flow of vapor; a vapor pump which receives the low pressure vapor and compresses the vapor stream to higher pressure and increased temperature; a cooled condenser which condenses the pressurized vapor to a liquid phase; and a heat exchanger which transfers heat from the condenser to the evaporator.

Aspect 36. The system of aspect 35 wherein the heat exchanger is a capillary evaporator as used in heat pipes.

Aspect 37. The system of aspect 35 wherein the heat exchanger contains an electrically powered thermoelectric heat pump.

Aspect 38. The system of aspect 34 wherein all operating pumps are dynamically mass balanced to transfer zero net angular momentum to the host platform.

Aspect 39. A method to reverse a phase-separation between liquid and vapor in fluids contained in microgravity environments, whereby a mixed-phase stream of fluid is first evaporated to complete vapor by passing in pulses through a fast acting valve into a low pressure volumetric region and then cooled and condensed to a complete liquid phase.

Aspect 40. A system comprising: a pressure vessel to contain a fluid consisting of both liquid and gas vapor phases; a vapor-pump and tubing to extract a portion of the fluid from the container into a flowing stream; a fast acting valve to divide the flowing stream into a series of separated pulses; a low pressure volumetric region where all liquid in the fluid pulse is evaporated to vapor; means to condense the vapor-only stream into a liquid-only stream; and means to deliver the liquid flow to a useful output.

Aspect 41. The system of aspect 40 wherein the means to condense a vapor-only stream contains an electrically powered thermoelectric heat pump.

Aspect 42. A Method for extracting both liquid and vapor phases of a fluid from a closed vessel whereby liquid is attached to and vapor is condensed to a liquid upon a surface of condensation whose temperature is kept below the dew point of the liquid but above its freezing temperature.

Aspect 43. A Method for moving a liquid from a surface of condensation into a pumping mechanism by means of capillary action wherein the liquid is drawn through a wicking material by surface tension forces and into the active volume of a liquid-phase pump.

Aspect 44. A Method for extracting an entrained liquid from the capillary action forces of a wicking material by means of compressing and reducing the volume of the wicking material thereby freeing a nearly incompressible liquid from the surface tension forces of capillary action.

Aspect 45. A Method for moving a liquid from a surface of condensation into a pumping mechanism by means of mechanically pushing or wiping across the condensing surface with a second moving surface.

Aspect 46. A System for extracting fluid from a closed vessel comprising: means to expose a liquid phase or a vapor phase of the fluid to a condensing surface fixed to a portion of the interior surface of the vessel, a condensing surface which has been cooled below the dew point temperature but above the freezing temperature of the fluid, a volumetric and compressible hydrophilic wicking material composed of a loosely packed fibrous structure which is in contact with the condensing surface and able to entrain the fluid into its volume by capillary action, a peristaltic-type pump which progressively compresses the wicking material along a wave that propagates along the wicking material and which forces liquid out of the wicking material and toward an output port where the liquid may be subsequently delivered to a useful purpose.

Aspect 47. The system of aspect 46 wherein the peristaltic pump is a roller pump.

Aspect 48. The system of aspect 46 wherein the peristaltic pump is a piston pump.

Aspect 49. The system of aspect 46 wherein the peristaltic pump is a hinged plate pump.

Aspect 50. A method for removing waste heat from a microwave power generator when operating in vacuum and/or microgravity environments comprising: an electrically powered microwave generator of nearly continuous power dissipation; a heat pipe with evaporator in communication with the heat generating surfaces of the microwave generator and with condenser in communication with a cold surface.

Aspect 51. A system of aspect 50, wherein the microwave generator is a microwave magnetron.

Aspect 52. A system of aspect 50, wherein the microwave generator is a component in a spacecraft.

Aspect 53. A system of aspect 50, wherein the microwave generator is a component in a space-based manufacturing system.

Aspect 54. A system of aspect 50, wherein the microwave generator is a component in a space mining system.

Aspect 55. A system of aspect 50, wherein the microwave generator is a component in a space communication or radar system.

Aspect 56. A system of aspect 50, wherein the microwave generator is a component in a directed energy or beamed power energy distribution system.

What is claimed:

1. A method for managing propellant in a spacecraft, the method comprising:
storing propellant in a tank as a mixture of liquid and gas;
transferring the propellant out of the tank;
converting the mixture of liquid and gas propellant into a single phase, where the single phase is either liquid or gaseous; and
supplying the single phase of the propellant to a thruster.

2. The method of claim 1, wherein
converting the propellant into a single phase includes converting the mixture of liquid and gas propellant directly into liquid.

3. The method of claim 2, wherein
converting the mixture of liquid and gas propellant directly into liquid includes compressing the propellant using a piston.

4. The method of claim 1, wherein
converting the mixture of liquid and gas propellant into the single phase includes converting the propellant directly into gas.

5. The method of claim 1, wherein
converting the mixture of liquid and gas propellant into the single phase includes:
first converting the mixture of liquid and gas propellant into gas, then converting the gas into liquid.

6. The method of claim 1, wherein converting the mixture of liquid and gas propellant into the single phase includes drawing the liquid through a wicking material into a pump.

7. The method of claim 6, further comprising:
causing a low-density vapor-phase of the propellant to condense onto a cooled complex surface at a temperature below a dew point of the propellant but above the freezing point of the propellant.

8. The method of claim 6, wherein the complex surface is composed of loosely packed hydrophilic fibers.

9. The method of claim 6, further comprising:
progressively compressing, using a peristaltic-type pump, the wicking material along a wave which forces liquid out of the wicking material and toward an output port.

10. The method of claim 1, wherein converting the mixture of liquid and gas propellant into the single phase includes:
evaporating the mixture to a complete vapor phase; and
condensing the complete vapor phase to a complete liquid phase.

11. The method of claim 10, wherein the evaporating includes:
directing a stream of the mixture through a restrictive orifice to generate an abrupt pressure drop to flash-evaporate the mixture.

12. The method of claim 11, wherein the condensing includes:
adding heat to the mixture using a warmed evaporator to generate a low-pressure vapor;
compressing a stream of the low-pressure vapor to generate a pressurized vapor with a higher pressure using a vapor pump; and
condensing the pressurized vapor to the complete liquid phase using a cooled condenser.

13. The method of claim 12, further comprising:
transferring heat from the cooled condenser to the warmed evaporator.

14. The method of claim 10, wherein evaporating the mixture to the complete vapor phase includes passing the mixture in pulses through a fast-acting valve into a low-pressure chamber.

15. A system comprising:
a tank storing propellant as a mixture of liquid and gas;
a thruster configured to consume the propellant to generate thrust; and
one or more components configured to implement of any of the preceding claims.
